(19) United States
(12) Patent Application Publication
(10) Pub. No.: US 2026/0109221 A1
(43) Pub. Date: Apr. 23, 2026

(54) PASSENGER SIDE INFOTAINMENT CONTROL

(71) Applicant: Scout Motors Inc., Tysons, VA (US)

(72) Inventors: Zachary Whitaker, Franklin, MI (US); Dwayne Jackson, Oakland Township, MI (US); Dean Bakker, Beverly Hills, MI (US); Evan Allen, Hazel Park, MI (US)

(21) Appl. No.: 18/923,322

(22) Filed: Oct. 22, 2024

(51) Int. Cl. B60K 35/22; G06F 3/0362; G06F 3/041; G06F 3/16

(52) U.S. Cl. CPC B60K 35/22; G06F 3/0362; G06F 3/0416; G06F 3/165; B60K 2360/126; B60K 2360/1438; B60K 2360/164

(57) ABSTRACT

A vehicle display may include a bezel. A vehicle display may include a screen supported by the bezel and defining a screen plane. A vehicle display may include a crown encoder supported by the bezel and including an encoder shaft defining an encoder axis parallel to the screen plane, and a grip coupled to the encoder shaft.

### BACKGROUND

This disclosure relates to vehicle displays. More particularly, this disclosure relates to controls for vehicle displays.

### SUMMARY

In some aspects, the techniques described herein relate to a vehicle display including: a bezel; a screen supported by the bezel and defining a screen plane; and a crown encoder supported by the bezel and including an encoder shaft defining an encoder axis parallel to the screen plane, and a grip coupled to the encoder shaft.

In some aspects, the techniques described herein relate to a vehicle display, wherein the grip and the encoder shaft are rotatable about the encoder axis, and translatable along the encoder axis between a first position and a second position.

In some aspects, the techniques described herein relate to a vehicle display, wherein the crown encoder further includes: a first rotary sensor located at the first position, and a second rotary sensor located at the second position.

In some aspects, the techniques described herein relate to a vehicle display, wherein the first rotary sensor is configured to provide volume information, and wherein the second rotary sensor is configured to provide setting adjustment information.

In some aspects, the techniques described herein relate to a vehicle display, wherein the grip and the encoder shaft are translatable along the encoder axis among the first position, the second position, and a third position.

In some aspects, the techniques described herein relate to a vehicle display, wherein the crown encoder further includes: a third momentary sensor located at the third position.

In some aspects, the techniques described herein relate to a vehicle display, wherein the third momentary sensor is configured to provide muting information.

In some aspects, the techniques described herein relate to a vehicle display, wherein the crown encoder is positioned on a passenger side of the bezel.

In some aspects, the techniques described herein relate to a vehicle display, wherein the bezel includes a flange partially surrounding the grip of the crown encoder.

In some aspects, the techniques described herein relate to a vehicle display, wherein the grip includes a gear tooth shaped grip surface.

In some aspects, the techniques described herein relate to a vehicle display, further including: one or more processing circuits including one or more non-transitory memory devices coupled to one or more processors, the one or more non-transitory memory devices configured to store instructions thereon that, when executed by the one or more processors, cause the one or more processors to: receive volume information from the crown encoder in response to rotation of the encoder shaft, and adjust a volume of an infotainment system based on the volume information.

In some aspects, the techniques described herein relate to a vehicle display, wherein the one or more non-transitory memory devices are further configured to store instructions thereon that, when executed by the one or more processors, cause the one or more processors to: receive occupancy information from a passenger occupancy sensor; and change operation of the crown encoder when the occupancy information indicates an absence of a passenger.

In some aspects, the techniques described herein relate to a vehicle display, wherein the grip and the encoder shaft are rotatable about the encoder axis, and translatable along the encoder axis among a first position, a second position, and a third position; wherein the crown encoder further includes: a first rotary sensor located at the first position and configured to provide the volume information, a second rotary sensor located at the second position and configured to provide setting adjustment information, and a third momentary sensor located at the third position configured to provide muting information, and wherein the one or more non-transitory memory devices are further configured to store instructions thereon that, when executed by the one or more processors, cause the one or more processors to: adjust a setting in response to the setting adjustment information, and mute the infotainment system in response to the muting information.

In some aspects, the techniques described herein relate to a vehicle display, wherein the one or more non-transitory memory devices are further configured to store instructions thereon that, when executed by the one or more processors, cause the one or more processors to: adjust a time or date setting of the vehicle display based on setting adjustment information received from the crown encoder.

In some aspects, the techniques described herein relate to a vehicle display, wherein the one or more non-transitory memory devices are further configured to store instructions thereon that, when executed by the one or more processors, cause the one or more processors to: mute the infotainment system in response to muting information received from the crown encoder.

In some aspects, the techniques described herein relate to a vehicle infotainment system including: a touchscreen display; and a rotary encoder coupled to a passenger side of the touchscreen display, the rotary encoder is configured to adjust a volume of the vehicle infotainment system in response to rotation and to mute the volume of the vehicle infotainment system in response to pressing the rotary encoder.

In some aspects, the techniques described herein relate to a vehicle infotainment system, wherein the touchscreen display defines a screen plane, and wherein the rotary encoder defines an encoder axis parallel to the screen plane.

In some aspects, the techniques described herein relate to a vehicle infotainment system, wherein the rotary encoder includes a gear tooth shaped grip surface, and wherein the touchscreen display includes a flange partially surrounding the gear tooth shaped grip surface of the rotary encoder.

In some aspects, the techniques described herein relate to a passenger side vehicle interface including: a crown positioned on a passenger side of a vehicle display; and an encoder coupled to the crown and including: a rotary volume sensor providing volume information in response to rotation of the crown, and a momentary muting sensor providing muting information in response to linear actuation of the crown.

In some aspects, the techniques described herein relate to a passenger side vehicle interface, wherein the encoder further includes a rotary settings sensor spaced apart from the rotary volume sensor and providing setting adjustment information in response to rotation of the crown.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1 is a perspective view of an infotainment system including a passenger side infotainment control, according to some implementations.

FIG. 2 is a front view of the infotainment system of FIG. 1.

FIG. 3 is a passenger side view of the infotainment system of FIG. 1.

FIG. 4 is a schematic view of the infotainment system of FIG. 1 in a first position, according to some implementations.

FIG. 5 is a schematic view of the infotainment system of FIG. 1 in a second position, according to some implementations.

FIG. 6 is a schematic view of a controller of the infotainment system of FIG. 1, according to some implementations.

FIG. 7 is a flow diagram of a method of operating the infotainment system of FIG. 1, according to some implementations.

FIG. 8 is a schematic diagram of a crown encoder usable with the infotainment system of FIG. 1, according to some implementations.

FIG. 9 is a schematic diagram of another crown encoder usable with the infotainment system of FIG. 1, according to some implementations.

FIG. 10 is a schematic diagram of another crown encoder usable with the infotainment system of FIG. 1, according to some implementations.

FIG. 11 is a schematic diagram of another crown encoder usable with the infotainment system of FIG. 1, according to some implementations.

FIG. 12 is a schematic diagram of another crown encoder usable with the infotainment system of FIG. 1, according to some implementations.

FIG. 13 is a schematic diagram of another crown encoder usable with the infotainment system of FIG. 1, according to some implementations.

FIG. 14A is a schematic diagram of another crown encoder usable with the infotainment system of FIG. 1, according to some implementations.

FIG. 14B is a schematic end view of the crown encoder of FIG. 14A, according to some implementations.

### DETAILED DESCRIPTION

Following below are more detailed descriptions of concepts related to, and implementations of, methods, apparatuses, and systems for a passenger side infotainment control. The figures illustrate exemplary implementations in detail and the present disclosure is not limited to the details or methodology set forth in the description or illustrated in the figures. The terminology used herein is for the purpose of description only and should not be regarded as limiting.

Referring to the figures generally, the various implementations disclosed herein relate to systems, apparatuses, and methods for a passenger side infotainment control for a vehicle infotainment system. The infotainment system includes a housing in the form of a bezel that supports a display in the form of a touchscreen. A crown encoder is supported by a passenger side of the bezel and is rotatable to adjust a volume of the infotainment system. The crown encoder can be momentarily pushed (e.g., like a button) to mute and unmute the infotainment system. In some implementations, the crown encoder can be pulled out to adjust a secondary function of the infotainment system (e.g., date and time). The crown encoder gives a manual control over the infotainment system to a passenger seated in a passenger seat of a vehicle.

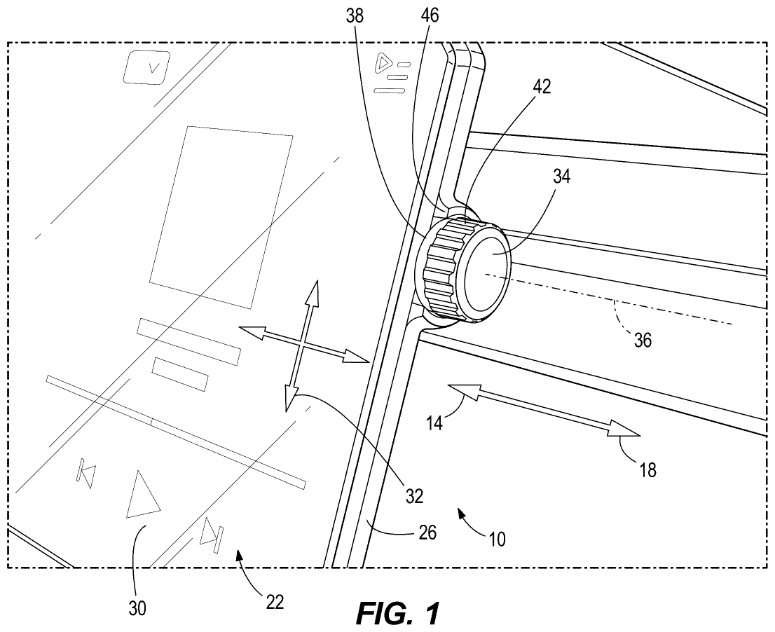

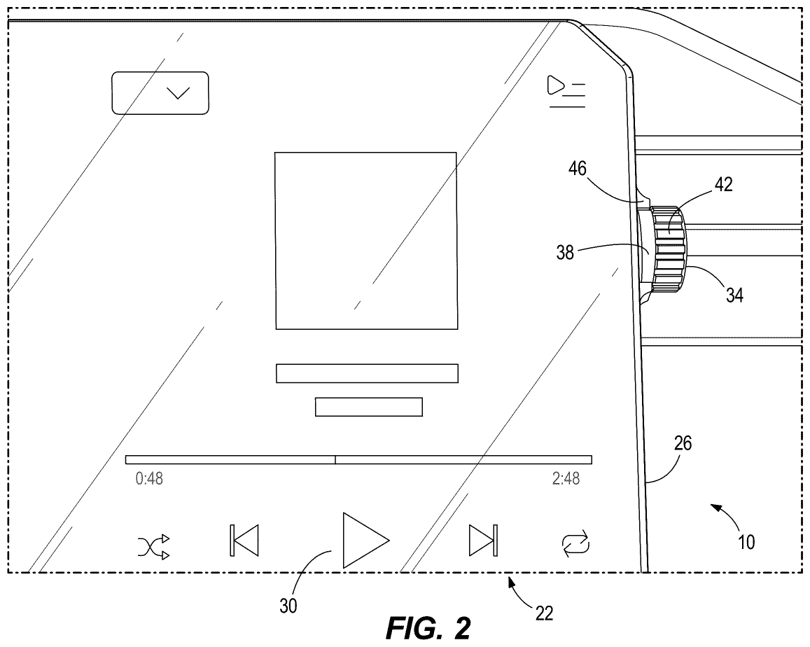

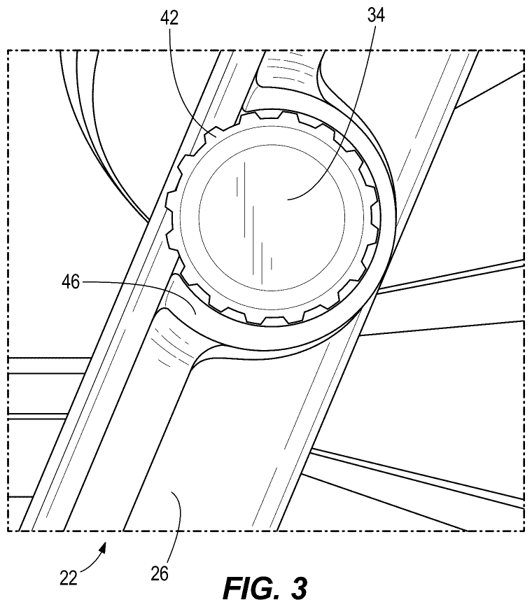

As shown in FIGS. 1-3, a vehicle dash 10 defines a driver side 14 and a passenger side 18. FIG. 1 shows a left-hand drive vehicle with the driver side 14 on the left. In some implementations, the vehicle is a right-hand drive vehicle with the driver side 14 on the right side. A vehicle display in the form of an infotainment system 22 is coupled to the vehicle dash 10 generally between a driver seat and a passenger seat. The infotainment system 22 includes a housing in the form of a bezel 26 that supports a display in the form of a screen 30 (e.g., a touch screen display) that defines a screen plane 32. In some implementations, the infotainment system 22 is a so-called bezel-less display and the housing or bezel 26 is hidden by the screen 30 when viewed form the front.

A rotary encoder in the form of a crown or a crown encoder 34 is supported by the bezel 26 and defines an encoder axis 36 that is parallel to the screen plane 32. The crown encoder 34 extends outward form the bezel 26 along the encoder axis 36 so that it rotates in a plane perpendicular to the encoder axis 36, as opposed to most infotainment knobs which rotate in a plane parallel to a screen plane about an axis that is perpendicular to the screen plane. The crown encoder 34 includes an encoder shank 38 and a grip 42 that defines a gear tooth shaped grip surface. The bezel 26 includes a flange 46 that extends at least partially around the encoder shank 38. In some implementations, the flange 46 extends at least partially around the grip 42. In some implementations, the flange 46 is eliminated. In some implementations, the encoder shank 38 is formed as a part of the grip 42 and defines a smaller diameter than the grip 42. The flange 46 is sized to at least partially surround the encoder shank 38 and define an inner diameter smaller than an outer diameter of the grip 42.

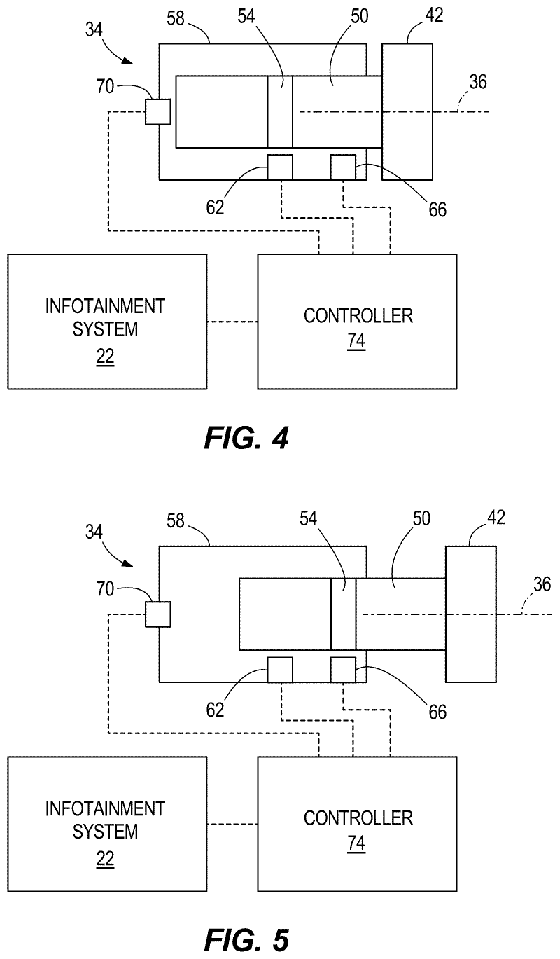

As shown in FIG. 4, the crown encoder 34 includes encoder shaft 50 extending from the grip 42 along the encoder axis 36 and including a shaft sensor 54. The grip 42 and the encoder shaft 50 are rotatable about the encoder axis 36 and translatable along the encoder axis 36 within an encoder housing 58. In some implementations, the grip 42 and the encoder shaft 50 are translatable between a first position (shown in FIG. 4) where the shaft sensor 54 is aligned with a first rotary sensor 62 supported by the encoder housing 58, a second position (shown in FIG. 5) where the shaft sensor 54 is aligned with a second rotary sensor 66 supported by the encoder housing 58, and a third position where the encoder shaft 50 interacts with a third momentary sensor 70 supported by the encoder housing 58. In some implementations, the first rotary sensor 62 and the second rotary sensor 66 include pickups and the shaft sensor 54 includes magnets positioned around a circumference of the shaft sensor 54 so that the first rotary sensor 62 and the second rotary sensor 66 than sense a magnetic field strength or other parameter (e.g., a change in magnetic field) and determine a relative position of the encoder shaft 50 within the encoder housing 58. Each of the first rotary sensor 62, the second rotary sensor 66, and the third momentary sensor 70 communicate with a controller 74 and with the infotainment system 22. In some implementations, the controller 74 is located within the bezel 26 of the infotainment system 22. In some implementations, when the grip 42 and the encoder shaft 50 are in the first position (see FIG. 4), the first rotary sensor 62 interacts with the shaft sensor 54 and the controller 74 adjusts a volume of the infotainment system 22. In some implementations, when the grip 42 and the encoder shaft 50 are in the second position (see FIG. 5), the second rotary sensor 66 interacts with the shaft sensor 54 and the controller 74 adjusts a setting of the infotainment system 22 such as a date and/or a time. In some implementations, the third position of the grip 42 and the encoder shaft 50 is a momentary position. For example, the third momentary sensor 70 can include a spring return microswitch and when the grip 42 and the encoder shaft 50 are moved into the third position (e.g., contact with the third momentary sensor 70) the controller 74 adjusts a mute or unmute setting of the infotainment system 22. In some implementations, the crown encoder 34 include mechanical detents to give the user haptic feedback regarding a position or a movement of the grip 42. In some implementations, the crown encoder 34 may provide haptic feedback via vibration or other mechanism based on sensed movement of the grip 42.

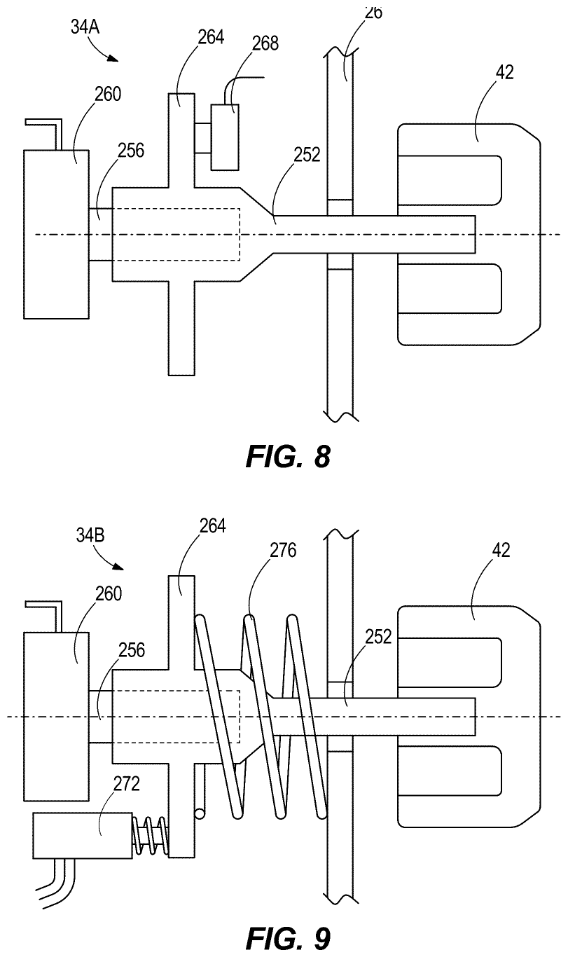

Translational and rotational actuation of the crown encoder 34 can be measured in a number of different ways. For example, rotation can be measured using a mechanical encoder, an optical encoder, an end mount magnetic encoder, a side mount magnetic encoder, etc. Linear position can be measured using individual mechanical switch(es), an optical barrier, individual hall effect sensors, a linear hall position encoder, etc. Linear position can be maintained using a mechanical detent, a magnetic detent, etc. A press (e.g., to the third position) can be detected using a mechanical switch, magnetic field intensity, etc. The crown encoder 34 can be implemented in a number of different ways. FIGS. 8-14B show seven different exemplary implementations of the crown encoder 34 that can be used with the systems discussed herein (e.g., the infotainment system 22, the controller 74, the method 200, etc.).

As shown in FIG. 8, in some implementations, the crown encoder 34 is implemented using a mechanical rotary encoder 34A. As shown, the mechanical rotary encoder 34A includes a first shaft 252 connected to the grip 42 and passing through the bezel 26. A second shaft 256 extends from an encoder sensor 260 and connects to the first shaft 252. The encoder sensor 260 is structured to send a signal to a controller (e.g., the controller 74 discussed below) indicative of a state of the mechanical rotary encoder 34A. A circularly symmetrical disc 264 extends from the first shaft 252 and is arranged to contact a momentary button 268 when a user pulls on grip 42, thereby depressing the momentary button 268 and sending a signal to a controller (e.g., the controller 74 discussed below). It will be appreciated that the symmetry of the circularly symmetrical disc 264 provides a continuous surface for depressing the momentary button 268 (e.g., at any point in the rotation of the grip 42). It should also be appreciated that the momentary button 268 could be implemented using a Hall effect sensor, thereby enabling sensing in both directions (e.g., push and pull).

As shown in FIG. 9, in some implementations, the crown encoder 34 is implemented using a mechanical encoder 34B similar to the mechanical rotary encoder 34A including a circularly symmetrical disc 264. A push latch mechanism 272 maintains the grip 42 and the first shaft 252 between a first position and a second position spaced from the first position along a shaft axis. The push latch mechanism 272 includes a first spring that biases the grip 42 outward. Pushing the grip 42 in against a bias of the first spring of the push latch mechanism 272 provides actuation from to the first position. A second spring 276 holds the grip 42 in the first position and biases against the circularly symmetrical disc 264 in a direction opposite to the first spring of the push latch mechanism 272. Pushing on the grip 42 again, actuates the push latch mechanism 272 and moves the grip 42 to the second position where it can be rotated for another function. The push latch mechanism 272 is configured to provide a signal indicative of a state of the mechanical encoder 34B. In particular, operation of the mechanical encoder 34B in the first position provides a first functionality and operation of the mechanical encoder 34B in the second position provides a second functionality. In other words, the configuration of the mechanical rotary encoder 34A shown in FIG. 9 provides that a user push in on grip 42 a first time to move from a first functionality to a second functionality, and that the user push in on grip 42 a second time to move from the second functionality back to the first functionality. To this point, it should be appreciated that the spring of the push latch mechanism 272 may be stronger than the second spring 276 such that the spring of the push latch mechanism 272 overpowers the second spring 276 when the user pushes in on the grip 42.

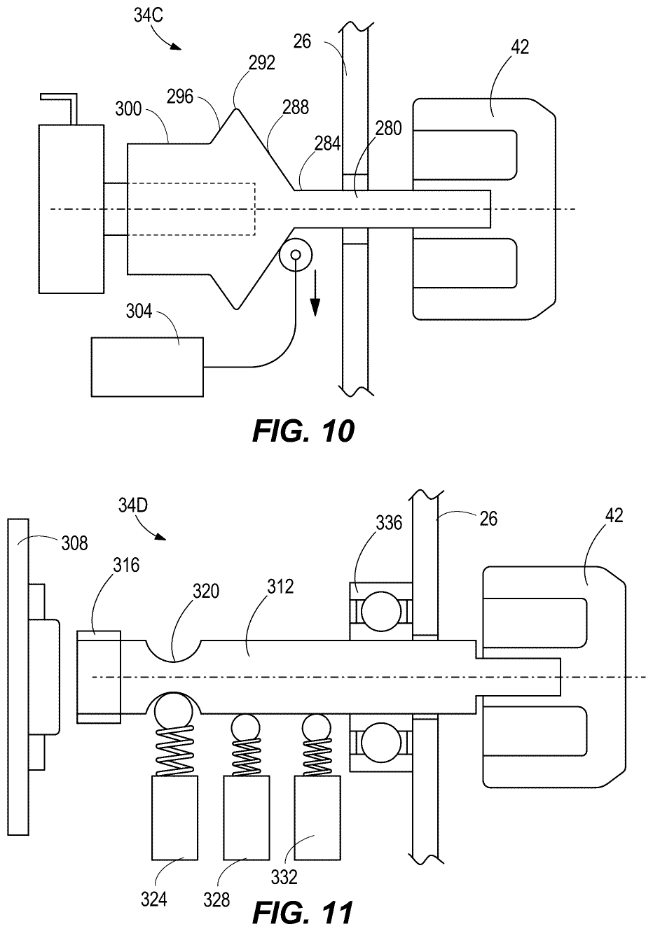

As shown in FIG. 10, in some implementations, the crown encoder 34 is implemented using a mechanical rotary encoder 34C that includes a first shaft 280 defining a collar having a first well 284, a first ramp 288, a peak 292, a second ramp 296, and a second well 300. The geometry of the collar interacts with a roller microswitch 304 to sense the position of the first shaft 280 and the grip 42 and hold it in two positions. In a first position, the roller microswitch 304 is arranged in contact with the first well 284 and rotation of the grip 42 provides a first functionality. As the user pulls the grip 42, the roller microswitch 304 rides up the first ramp 288 (as shown in FIG. 10) until the roller microswitch 304 passes the peak 292 and rolls down the second ramp 296 to the second well 300. When the roller microswitch 304 is arranged in the second well 300, a second functionality is provided. The first ramp 288 interacts with the roller microswitch 304 to bias the first shaft 280 to the first position. The second ramp 296 interacts with the roller microswitch 304 to bias the first shaft 280 toward the second position. The roller microswitch 304 also acts as detent to keep the first shaft 280 and the grip 42 in place. In some implementations, the mechanical rotary encoder 34C uses a separate spring-loaded detent to hold the grip 42 and the first shaft 280 in the first position and the second position, and the roller microswitch 304 is only used to measure the position separately (e.g., magnetically, optically, etc.).

As shown in FIG. 11, the crown encoder 34 is implemented using an end-mount magnetic encoder 34D that includes a magnet and rotary hall effect sensor 308 that communicates with a controller (e.g., the controller 74 discussed below) and an encoder shaft 312 connected to the grip 42 and including an encoder magnet 316 positioned to magnetically interact with the magnet and rotary hall effect sensor 308. The encoder shaft 312 also defines a detent recess 320 sized to receive a first detent 324, a second detent 328, or a third detent 332. The detents 324, 328, 332 interact with the detent recess 320 to maintain the encoder shaft 312 in a first position associated with the first detent 324, a second position associated with the second detent 328, or a third position associated with the third detent 332. The first position, the second position, and the third position are each associated with a different function and different control signals are sent to the controller for control of various vehicle and infotainment system 22 actions. In some implementations, the magnet and rotary hall effect sensor 308 outputs analog field measurements that can be processed by the controller to determine the distance between the magnet and rotary hall effect sensor 308 and the encoder magnet 316 and implement on of the three functions accordingly. In some implementations, the first detent 324 is shaped to inhibit the encoder shaft 312 from travelling past the first position toward the magnet and rotary hall effect sensor 308. In some implementations, the grip 42 is arranged to bottom out or contact the bezel 26 or the flange 46 to inhibit moving past the first position. In some implementations, the first detent 324 includes a first switch that sends a first position signal when the encoder shaft 312 is arranged in the first position, the second detent 328 includes a second switch that sends a second position signal when the encoder shaft 312 is arranged in the second position, and the third detent 332 includes a third switch that sends a third position signal when the encoder shaft 312 is arranged in the third position. In some implementations, the encoder shaft 312 is supported by a bearing 336 that allows rotational and linear movement.

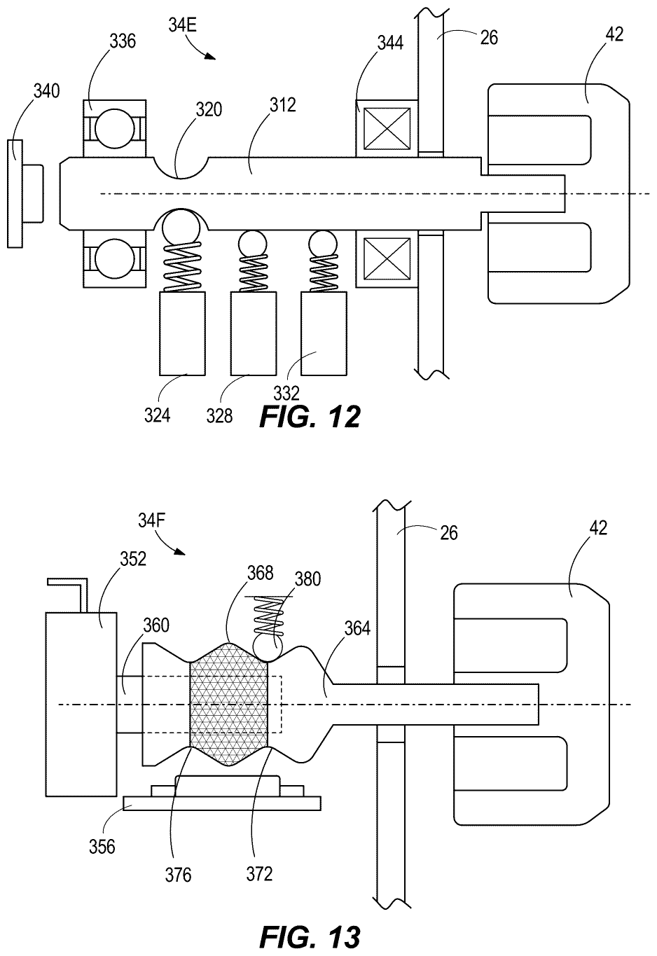

As shown in FIG. 12, the crown encoder 34 is implemented using a pass-through encoder 34E (e.g., mechanical, optical, or rotary) that is similar to the end-mount magnetic encoder 34D and includes similar parts labeled with matching reference numbers. The pass-through encoder 34E includes a mechanical button 340 positioned to physically engage the encoder shaft 312 for a momentary press and send a signal to a controller indicative of the momentary press. The pass-through encoder 34E also includes a pass-through encoder 344 that detects rotational movement of the encoder shaft 312 and sends a signal to the controller. In some implementations, the pass-through encoder 344 is a toothed wheel with optical sensors. As with the pass-through encoder 34E, the first position, second position, and the third position can be sensed by switches within the detents 324, 328, 332 or using another sensor (e.g., a hall effect sensor). In some implementations, the detent mechanisms 324, 328, 332 can be clocked around the encoder shaft 312 (i.e., positioned at offset positions about the circumference of the encoder shaft 312) instead of in a line to provide a more compact system. In some implementations, the mechanical button 340 is optical.

As shown in FIG. 13, the crown encoder 34 is implemented using a linear magnetic encoder 34F that includes a rotary encoder 352 and a linear hall effect sensor 356. The rotary encoder 352 includes a push button structured to send a signal when it senses a momentary push, and a first encoder shaft 360. A second encoder shaft 364 connects to the first encoder shaft 360 and the grip 42. The second encoder shaft 364 defines a magnetic peak 368, a first detent recess 372, and a second detent recess 376 positioned on an opposite side of the magnetic peak 368 from the first detent recess 372. A detent mechanism 380 is sized to engage the first detent recess 372 or the second detent recess 376 and maintain the second encoder shaft 364 in a first position or a second position. The magnetic peak 368 is structured to interact with the linear hall effect sensor 356 and provide a position signal to a controller. The rotary encoder 352 provides rotational information and momentary push information to the controller. The linear hall effect sensor 356 and the rotary encoder 352 allow the linear magnetic encoder 34F to provide control signals for the vehicle and/or infotainment system 22.

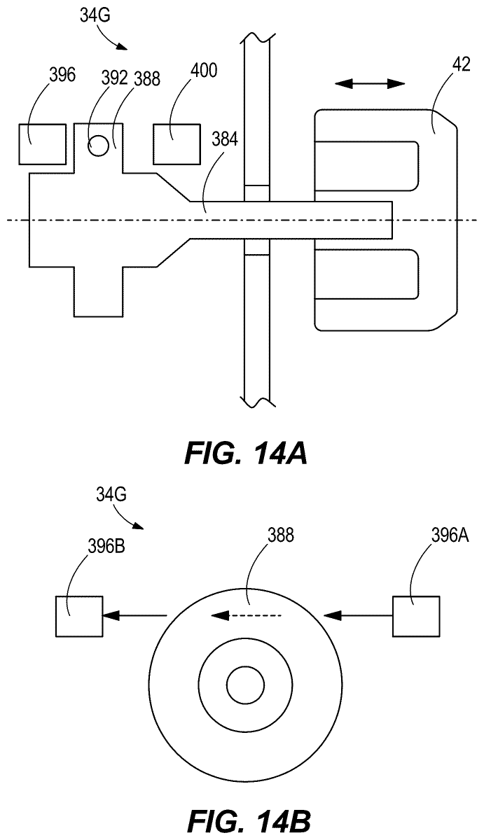

As shown in FIGS. 14A and 14B, various aspects of the crown encoders discussed above can be implemented using optical sensing. For example, an optical sensor 34G could be used to sense linear position. The optical sensor 34G includes an encoder shaft 384 defining a radial disc 388 and a beam blocking portion 392 of the radial disc 388. The optical sensor 34G also includes a first optical sensor 396 and a second optical sensor 400 spaced from the first optical sensor 396 along a shaft axis. As shown in FIG. 14B, each optical sensor includes a light sender in the form of an LED 396A and a photo diode sensor 396B aligned with the LED 396A. When a light beam from the LED 396A strikes the photo diode sensor 396B, a first signal is sent by the photo diode sensor 396B to a controller indicating that the encoder shaft 384 is not in the corresponding position. When the beam blocking portion 392 is positioned between the LED 396A and the 396B, light is inhibited from striking the 396B and a second signal is sent to the controller indicative of the encoder shaft 384 being arranged in the corresponding position. In some implementations, the second signal is 0 V. While two positions are shown in FIGS. 14A and 14B, this structure can be extended to an arbitrary number of positions using a method similar to quadrature encoding or gray code to limit the number of sensors required by using their position and the geometry of the shaft. Overlapping the bodies of the sensors is possible because you can clock them around the shaft to make the assembly more compact.

While seven implementations of the crown encoder 34 are described with reference to FIGS. 8-14B, other alternatives are contemplated within the scope of the accompanying claims and the encoders 34A-G are exemplary. Those of skill in the art will understand that various features of one example may be combined with another example to provide the functionalities of the crown encoder 34 described herein.

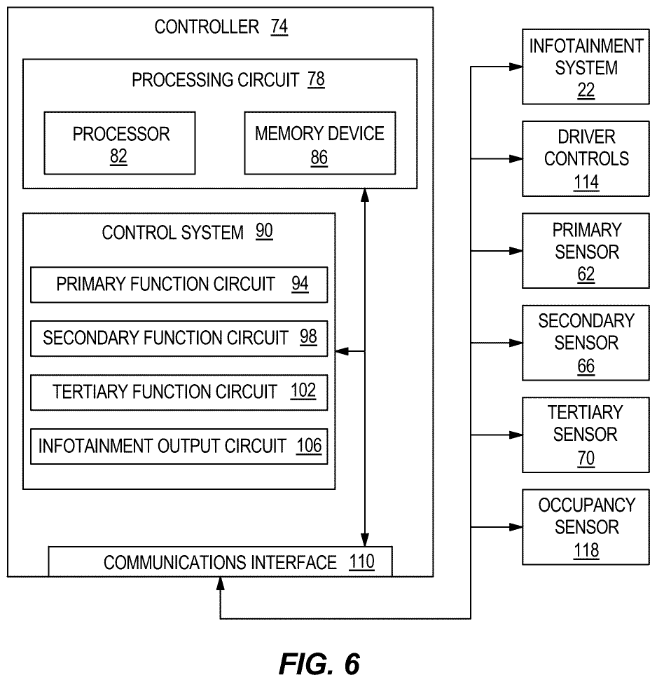

Referring now to FIG. 6, a schematic diagram of the controller 74 is shown according to an example implementation. As shown in FIG. 6, the controller 74 includes a processing circuit 78 having a processor 82 and a memory device 86, a control system 90 having a primary function circuit 94 associated with the first rotary sensor 62, a secondary function circuit 98 associated with the second rotary sensor 66, a tertiary function circuit 102 associated with the third momentary sensor 70, and an infotainment output circuit 106, and a communications interface 110. Generally, the controller 74 is structured to receive information from the crown encoder 34 and modify operation of the infotainment system 22 based on the received information. For example, in some implementations, the received information causes the controller 74 to adjust a volume, a mute or unmute setting, and/or a date and time of the infotainment system 22. However, it should be appreciated that the controller 74 may modify other aspects of the infotainment system 22 based on manipulation of the crown encoder 34 (e.g., moving between songs, adjusting a radio station, adjusting climate control settings, etc.) in various other implementations.

In one configuration, the circuits of the control system 90 are in the form of machine or computer-readable media that is executable by a processor, such as processor 82. As described herein, the machine-readable media facilitates performance of certain operations to enable reception and transmission of data. For example, the machine-readable media may provide an instruction (e.g., command, etc.) to acquire data. In this regard, the machine-readable media may include programmable logic that defines the frequency of acquisition of the data (or, transmission of the data). The computer readable media may include code written in any programming language. The computer readable program code may be executed on one processor, multiple co located processors, multiple remote processors, or any combination of local and remote processors. Remote processors may be connected to each other through any type of network (e.g., CAN bus, etc.). In this regard, while the controller 74 is generally described herein as an individual component (e.g., a dedicated controller in communication with the infotainment system 22), it should be appreciated that the controller 74 could be implemented via one or more other controllers of a vehicle. For example, the functionality of the controller 74, as described herein, may be implemented by one or more of a vehicle control module (VCU), electronic control unit (ECU), an infotainment control module (ICM), or the like, as described in greater detail below.

In some implementations, the circuits of the control system 90 are implemented as hardware units, such as electronic control units. As such, the circuits of the control system 90 may be implemented as one or more circuitry components including, but not limited to, processing circuitry, network interfaces, peripheral devices, input devices, output devices, sensors, etc. In some implementations, the circuits of the control system 90 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the circuits of the control system 90 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The circuits of the control system 90 may also include programmable hardware devices such as field programmable gate arrays, programmable array logic, programmable logic devices or the like. The circuits of the control system 90 may include one or more memory devices for storing instructions that are executable by the processor(s) of the circuits of the control system 90. The one or more memory devices and processor(s) may have the same definition as provided below with respect to the memory device 86 and processor 82. In some hardware unit configurations, the circuits of the control system 90 may be geographically dispersed throughout separate locations in the power system. Alternatively and as shown, the circuits of the control system 90 may be implemented in or within a single unit/housing, which is shown as the controller 74.

In the example shown, the controller 74 includes the processing circuit 78 having the processor 82 and the memory device 86. The processing circuit 78 may be structured or configured to execute or implement the instructions, commands, and/or control processes described herein with respect to the circuits of the control system 90. The depicted configuration represents the circuits of the control system 90 as machine or computer-readable media. However, as mentioned above, this illustration is not meant to be limiting as the present disclosure contemplates other implementations where the circuits of the control system 90, or at least one circuit of the circuits of the control system 90, is configured as a hardware unit. All such combinations and variations are intended to fall within the scope of the present disclosure.

The hardware and data processing components used to implement the various processes, operations, illustrative logics, logical blocks, modules and circuits described in connection with the implementations disclosed herein (e.g., the processor 82) may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some implementations, the one or more processors may be shared by multiple circuits (e.g., the circuits of the control system 90 may comprise or otherwise share the same processor which, in some example implementations, may execute instructions stored, or otherwise accessed, via different areas of memory). Alternatively or additionally, the one or more processors may be structured to perform or otherwise execute certain operations independent of one or more co-processors. In other example implementations, two or more processors may be coupled via a bus to enable independent, parallel, pipelined, or multi-threaded instruction execution. All such variations are intended to fall within the scope of the present disclosure.

The memory device 86 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 86 may be communicably connected to the processor 82 to provide computer code or instructions to the processor 82 for executing at least some of the processes described herein. Moreover, the memory device 86 may be or include tangible, non-transient volatile memory or non-volatile memory. Accordingly, the memory device 86 may include database components, object code components, script components, or any other type of information structure for supporting the various activities and information structures described herein.

The primary function circuit 94 is structured to receive primary function information from the first rotary sensor 62 and provide a primary function output to the infotainment output circuit 106 based on the primary function information. In some implementations, the primary function information includes rotational position information based on the relative position of the shaft sensor 54 and the first rotary sensor 62 when the grip 42 and the encoder shaft 50 are in the first position. In some implementations, the primary function output is indicative of a volume (e.g., turning the grip 42 clockwise results in increased volume and turning the grip 42 counterclockwise results in decreased volume).

The secondary function circuit 98 is structured to receive secondary function information from the second rotary sensor 66 and provide a secondary function output to the infotainment output circuit 106 based on the secondary function information. In some implementations, the secondary function information includes rotational position information based on the relative position of the shaft sensor 54 and the second rotary sensor 66 when the grip 42 and the encoder shaft 50 are in the second position. In some implementations, the secondary function output includes setting adjustment information. In some implementations, the setting adjustment information includes a date and/or time that is displayed by the infotainment system 22. In some implementations, the setting adjustment information includes a radio station tuning. In some implementations, the setting adjustment information includes a mode selection (e.g., radio, Bluetooth®, Aux, CarPlay®, Android Auto®, etc.). The setting adjustment information can be any setting of the infotainment system 22 that it is desirable to adjust from the passenger side 18 of the vehicle.

The tertiary function circuit 102 is structured to receive tertiary function information from the third momentary sensor 70 and provide a tertiary function output to the infotainment output circuit 106 based on the tertiary function information. In some implementations, the tertiary function information includes a momentary signal based on the depression of the third momentary sensor 70 (e.g., a spring return microswitch) by the encoder shaft 50 in the third position. In some implementations, the tertiary function output includes an alternating mute and unmute signal (e.g., muting information) so that pressing the grip 42 and the encoder shaft 50 repeatedly into the third position results in muting and unmuting the infotainment system 22. In some implementations, the tertiary function information includes a select function. For example, when the grip 42 and the encoder shaft 50 are arranged in the second position and the secondary function information is being processed by the secondary function circuit 98, the user can press the grip 42 and the encoder shaft 50 into the third position and the tertiary function circuit 102 will determine a selection has been made and provide a selection information to the secondary function circuit 98 to save the current setting adjustment information.

The infotainment output circuit 106 is structured to receive the primary function output from the primary function circuit 94, the secondary function output from the secondary function circuit 98, and the tertiary function output from the tertiary function circuit 102 and control operation of the infotainment system 22 via the communications interface 110. In some implementations, the infotainment output circuit 106 is also structured to receive information from driver controls 114 that include a steering wheel control interface and/or a control interface located adjacent the driver side 14 of the infotainment system 22 or underneath the infotainment system 22. The infotainment output circuit 106 receives information from the driver controls 114 and adjusts operation of the infotainment system 22 based on both the information received from the first rotary sensor 62, the second rotary sensor 66, and the third momentary sensor 70, and the driver controls 114. In some implementations, the infotainment output circuit 106 is also structured to receive information from an occupancy sensor 118 (e.g., a pressure sensor in the seat, a seatbelt sensor, a cabin-facing camera, etc.) structured to determine the presence or absence of a passenger in the passenger seat. When a passenger is present, the functions of the crown encoder 34 are enabled and adjustments can be made from the passenger side 18 of the infotainment system 22. When the passenger is absent, the functions of the crown encoder 34 are disabled and adjustments cannot be made from the passenger side 18 of the infotainment system 22.

In some implementations, the second rotary sensor 66 and the second position of the grip 42 and the encoder shaft 50 are eliminated. In some implementations the third momentary sensor 70 and the third position are eliminated. In some implementations, the occupancy sensor 118 is eliminated.

While various circuits with particular functionality are shown in FIG. 6, it should be understood that the controller 74 may include any number of circuits for completing the functions described herein. For example, the activities and functionalities of the circuits of the control system 90 may be combined in multiple circuits or as a single circuit. Additional circuits with additional functionality may also be included. Further, the controller 74 may further control other activity beyond the scope of the present disclosure. In some implementations, the circuits described herein may include one or more processing circuits comprising one or more memory devices coupled to one or more processors, the one or more memory devices configured to store instructions thereon that, when executed by the one or more processors, cause the one or more processors to perform the operations performed herein and described with reference to circuits.

As mentioned above and in one configuration, the “circuits” may be implemented in machine-readable medium for execution by various types of processors, such as the processor 82 of FIG. 6. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be implemented in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some implementations, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

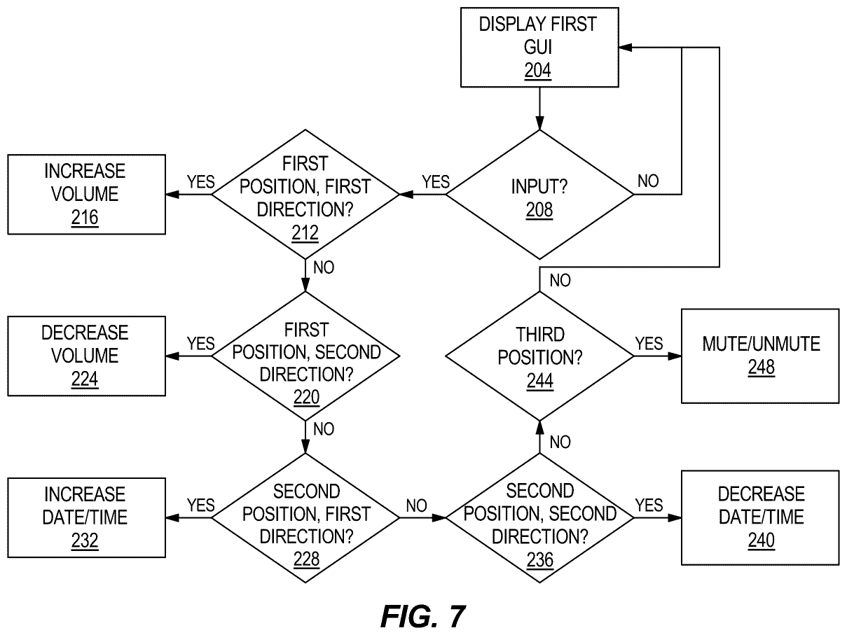

As shown in FIG. 7, in operation, a user sitting in the passenger seat of a vehicle can interact with the infotainment system 22 via the crown encoder 34 generally following a method 200. The method includes displaying a first graphical user interface (GUI) via the screen 30 at step 204. Then if the infotainment system 22 receives user input at step 208, then the controller 74 determines a position. If the encoder shaft 50 is in the first position and rotated in a first direction (e.g., clockwise) at step 212, then volume is increased at step 216. If the encoder shaft 50 is in the first position and rotated in a second direction (e.g., counterclockwise) at step 220, then volume is decreased at step 224. If the encoder shaft 50 is moved to the second position and rotated in a first direction (e.g., clockwise) at step 228, then a time or date (or other setting information) is increased at step 232. If the encoder shaft 50 is moved to the second position and rotated in a second direction (e.g., counterclockwise) at step 236, then a time or date (or other setting information) is decreased at step 240. The user can also press the grip 42 toward the bezel 26 to mute or unmute the infotainment system 22. If the encoder shaft 50 is moved to the third position at step 244, then the controller 74 mutes/unmutes the infotainment system 22 at step 248. The action of the crown encoder 34 coordinates with other controls of the infotainment system 22 such as those found on a steering wheel or under the screen 30 and in addition to touch functionality of the screen 30 itself.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

1. A vehicle display comprising:
a bezel having a driver side and a passenger side;
a screen supported by the bezel and defining a screen plane, the screen providing a touch functionality configured to control an infotainment function; and
a crown encoder supported by the passenger side of the bezel and including
an encoder shaft defining an encoder axis parallel to the screen plane and extending toward the passenger side, and
a grip coupled to the encoder shaft,
wherein the crown encoder is configured to provide supplemental control of the infotainment function, and
wherein the crown encoder is positioned to be used by a passenger and not a driver.

2. The vehicle display of claim 1, wherein the grip and the encoder shaft are rotatable about the encoder axis, and translatable along the encoder axis between a first position and a second position.

3. The vehicle display of claim 2, wherein the crown encoder further includes:
a first rotary sensor located at the first position, and
a second rotary sensor located at the second position.

4. The vehicle display of claim 3, wherein the first rotary sensor is configured to provide volume information, and
wherein the second rotary sensor is configured to provide setting adjustment information.

5. The vehicle display of claim 2, wherein the grip and the encoder shaft are translatable along the encoder axis among the first position, the second position, and a third position.

6. The vehicle display of claim 5, wherein the crown encoder further includes:
a third momentary sensor located at the third position.

7. The vehicle display of claim 6, wherein the third momentary sensor is configured to provide muting information.

8. (canceled)

9. The vehicle display of claim 1, wherein the bezel includes a flange partially surrounding the grip of the crown encoder.

10. The vehicle display of claim 1, wherein the grip includes a gear tooth shaped grip surface.

11. The vehicle display of claim 1, further comprising:
a controller, wherein the controller comprises at least one processor, and memory having instructions stored thereon that, when executed by the at least one processor, cause the controller to:
receive volume information from the crown encoder in response to rotation of the encoder shaft, and
adjust a volume of an infotainment system based on the volume information.

12. The vehicle display of claim 11, wherein the memory is further configured to store the instructions thereon that, when executed by the at least one processor, cause the at least one processor to:
receive occupancy information from a passenger occupancy sensor; and
change operation of the crown encoder when the occupancy information indicates an absence of a passenger.

13. The vehicle display of claim 11, wherein the grip and the encoder shaft are rotatable about the encoder axis, and translatable along the encoder axis among a first position, a second position, and a third position;
wherein the crown encoder further includes:
a first rotary sensor located at the first position and configured to provide the volume information,
a second rotary sensor located at the second position and configured to provide setting adjustment information, and
a third momentary sensor located at the third position configured to provide muting information, and
wherein the memory is further configured to store the instructions thereon that, when executed by the at least one processor, cause the at least one processor to:
adjust a setting in response to the setting adjustment information, and
mute the infotainment system in response to the muting information.

14. The vehicle display of claim 11, wherein the memory is further configured to store the instructions thereon that, when executed by the at least one processor, cause the at least one processor to:
adjust a time or date setting of the vehicle display based on setting adjustment information received from the crown encoder.

15. The vehicle display of claim 11, wherein the memory is further configured to store the instructions thereon that, when executed by the at least one processor, cause the at least one processor to:
mute the infotainment system in response to muting information received from the crown encoder.

16. A vehicle infotainment system comprising:
a touchscreen display defining a driver side, a passenger side, and a screen plane; and
a rotary encoder coupled to the passenger side of the touchscreen display wherein the rotary encoder:
defines an encoder axis parallel to the screen plane,
extends away from the passenger side of the touchscreen display, and
is configured to adjust a volume of the vehicle infotainment system in response to rotation and to mute the volume of the vehicle infotainment system in response to pressing the rotary encoder.

17. (canceled)

18. The vehicle infotainment system of claim 16, wherein the rotary encoder includes a gear tooth shaped grip surface, and
wherein the touchscreen display includes a flange partially surrounding the gear tooth shaped grip surface of the rotary encoder.

19. A passenger side vehicle interface comprising:
a crown positioned on a passenger side of a vehicle display and extending in a direction away from a driver side; and
an encoder coupled to the crown and including:
a rotary volume sensor providing volume information in response to rotation of the crown, and
a momentary muting sensor providing muting information in response to linear actuation of the crown,
wherein the volume information and the muting information are supplemental to volume information and muting information provided by a driver control, and
wherein the encoder is positioned to provide primary control to a passenger.

20. The passenger side vehicle interface of claim 19, wherein the encoder further includes a rotary settings sensor spaced apart from the rotary volume sensor and providing setting adjustment information in response to rotation of the crown.
